(19) United States
(12) Patent Application Publication
(10) Pub. No.: US 2012/0265505 A1
(43) Pub. Date: Oct. 18, 2012

(54) METHOD FOR SIMULATING BEHAVIOR IN A RECONFIGURABLE INFRASTRUCTURE AND SYSTEM IMPLEMENTING SAID METHOD

(75) Inventors: Christophe Meyer, Velizy Cedex (FR); Fabien Flacher, Velizy Cedex (FR); Nicolas Pays, Velizy Cedex (FR)

(73) Assignee: Thales, Neuilly Sur Seine (FR)

(21) Appl. No.: 13/381,472

(22) PCT Filed: Jul. 2, 2010
(86) PCT No.: PCT/EP2010/059455

§ 371 Date: Jun. 1, 2012

(30) Foreign Application Priority Data
Jul. 2, 2009 (FR) 0954527

(51) Int. Cl. G06G 7/48

(52) U.S. Cl. 703/6

(57) ABSTRACT

A technique for simulating behaviors in a reconfigurable infrastructure represented in three dimensions and including interactive objects. Characteristics of an interactive object are described in an object profile, users in the infrastructure simulated by intelligent agents, an agent described in an agent profile including information indicating a main objective of said agent, executing a trajectory calculation process associated with a given agent including at least three steps: (1) profiles of the interactive objects are analyzed; (2) a trajectory is calculated or recalculated with the help of a path-search algorithm; (3) a check is performed to verify whether the trajectory is valid; if the trajectory is valid, the trajectory is taken into account for the movements of the intelligent agent; if the trajectory is not valid, at least one constraint included in an interactive object profile invalidating the trajectory is identified and the process is executed again from the first step.

The invention relates to a method for simulating behaviors in a reconfigurable infrastructure and to a system implementing the method. It applies notably to the fields of the design, layout and control of infrastructures and artificial intelligence.

In order to choose the way in which an infrastructure which is to be constructed or adapted is laid out, several aspects are customarily taken into account.

Thus, physical aspects specific to the environment in which the infrastructure is or will be installed are considered. These lead to the definition of plans, materials used, means for circulating within the infrastructure or infrastructures. For example, specific equipment for a transport infrastructure accommodating the public, such as a display system, ticketing systems or counters may be required. Supervision means may also be required, these means corresponding for example to staff or access control devices.

Aspects related to the procedures to be put in place in the infrastructure are also taken into account. These aspects are for example related to security procedures, to procedures for safeguarding the public and staff of the infrastructure, as well as to the analysis of the circulation of the staff and the public.

Indeed the way in which the objects making up said infrastructure are laid out, such as for example the dividing walls between various zones or the furniture, have an impact on these aspects.

There exist numerous schemes making it possible to represent in three dimensions an existing infrastructure or one which is to be constructed. In the description, an infrastructure designates, for example, a railroad station, an airport or any building. Most of these schemes for three-dimensional representation only make it possible to represent sites in a static manner, for example the walls. The way in which the users of this infrastructure will circulate within these sites is not jointly simulated.

Moreover, there exist simulation schemes making it possible to animate virtual representations of infrastructures. For example, such schemes make it possible to evaluate the plans for evacuating infrastructures in case of fire. In this case, the models rely mainly on discrete-event simulation approaches or are based on simple behavioral laws. The representation of the sites is customarily static. It has been carried out prior to the simulations which utilize them and the means of interaction between the infrastructures and the users of said infrastructures who will populate them are pre-existing at the start of the simulations, said users being simulated with the help of virtual agents.

The prior art does not make it possible to modify in real time the configuration of the sites in which the simulations are implemented. No simple means exists for dynamically modifying the possible interactions between virtual agents and the representations of infrastructures.

By way of example, in such approaches of the prior art, if the objective is to evaluate the effect resulting from the addition of a new access control on the flows of passengers in an airport, it is necessary to stop the simulations in progress. The new access control is simulated in the three-dimensional model of the airport and all the impacts of this introduction are described in the passenger behavior models. The simulations can thereafter be executed again. The three-dimensional representation of infrastructures is not easy and a user of a three-dimensional modeling system must have specific skills to be able to adapt the representation of the infrastructure. Moreover, this step requires a significant production time.

An aim of the invention is notably to alleviate the aforementioned drawbacks.

For this purpose the subject of the invention is a method for simulating behaviors in a reconfigurable infrastructure represented in three dimensions, said infrastructure being composed of interactive objects. The characteristics of an interactive object are described in an object profile. The behavior of users of the infrastructure able to move around therein is simulated by intelligent agents, the characteristics of an intelligent agent being described in an agent profile comprising at least one item of information indicating the main objective of said intelligent agent. A trajectory calculation process associated with a given agent is executed and comprises at least three steps.

In a first step, the profiles of the interactive objects of the infrastructure are analyzed and those whose use by the agent is required in order to reach an objective termed the current objective are identified, the current objective corresponding initially to the main objective.

In a second step, a trajectory is calculated or recalculated with the help of a path-search algorithm, said trajectory making it possible to reach the main objective by using the interactive objects identified in the previous step.

In a third step, a check is performed to verify whether the trajectory calculated during the second step is valid. If such is the case, the latter is taken into account for the movements of the intelligent agent; if the trajectory is not valid, at least one constraint contained in an interactive object profile invalidating the trajectory is identified and the process is executed again from the first step, the current objective being to satisfy the identified constraint.

The main objective of an agent corresponds for example to a geographical destination in the three-dimensional representation of the infrastructure.

According to one aspect of the invention, during the first step of a process associated with a given intelligent agent, the analysis of the profiles of the interactive objects is carried out on the profiles of the interactive objects present in a given radius R around the current position of the agent.

According to another aspect of the invention, when the calculated trajectory is not valid and at least one constraint contained in the invalidating interactive object profile cannot be satisfied, the intelligent agent remains stationary.

Interactive objects and/or intelligent agents may be added or removed at any moment in the three-dimensional representation of the infrastructure.

According to one embodiment, the profiles of the interactive objects and the profiles of the intelligent agents are modifiable at any moment of the execution of the method.

The trajectory calculation processes associated with the intelligent agents are executed periodically, for example.

In one mode of implementation of the invention, the trajectory calculation process associated with a given intelligent agent is executed when an object profile or an agent profile is modified as well as when an interactive object or an intelligent agent is added to the three-dimensional representation of the infrastructure.

The subject of the invention is also a system for simulating behaviors in a reconfigurable infrastructure represented in three dimensions, said infrastructure being composed of interactive objects. The characteristics of an interactive object are described in an object profile. The behavior of users of the infrastructure able to move around therein is simulated by intelligent agents, the characteristics of an intelligent agent being described in an agent profile comprising at least one item of information indicating the main objective of said intelligent agent. A trajectory calculation process associated with a given agent is executed and comprises at least three steps. In a first step, the profiles of the interactive objects of the infrastructure are analyzed and those whose use by the agent is required in order to reach an objective termed the current objective are identified, the current objective corresponding initially to the main objective. In a second step, a trajectory is calculated or recalculated with the help of a path-search algorithm, said trajectory making it possible to reach the main objective by using the interactive objects identified in the previous step. In a third step, a check is performed to verify whether the trajectory calculated during the second step is valid. If such is the case, the latter is taken into account for the movements of the intelligent agent; if the trajectory is not valid, at least one constraint contained in an interactive object profile invalidating the trajectory is identified and the process is executed again from the first step, the current objective being to satisfy the identified constraint.

The method according to the invention has notably the advantages of allowing the fast implementation of infrastructure simulation and of automatically taking into account the modifications of the modeled infrastructure which are introduced during simulation. The fast simulation of behaviors, for example human behaviors, or/and flows of people within an infrastructure is made possible by allowing the modification of the environment by the addition and/or the removal of interactive objects and/or of intelligent agents capable of interacting with one another and originating from libraries placed at the disposal of the user of a system implementing the method. It is not necessary for a user to know how to program a computer in order to use a system implementing the method according to the invention. It is thus very easy to test new configurations of infrastructures by simply introducing new interactive objects or intelligent agents and/or by modifying existing interactive objects or intelligent agents.

Other characteristics and advantages of the invention will become apparent with the help of the description which follows given by way of nonlimiting illustration, offered with regard to the appended drawings among which:

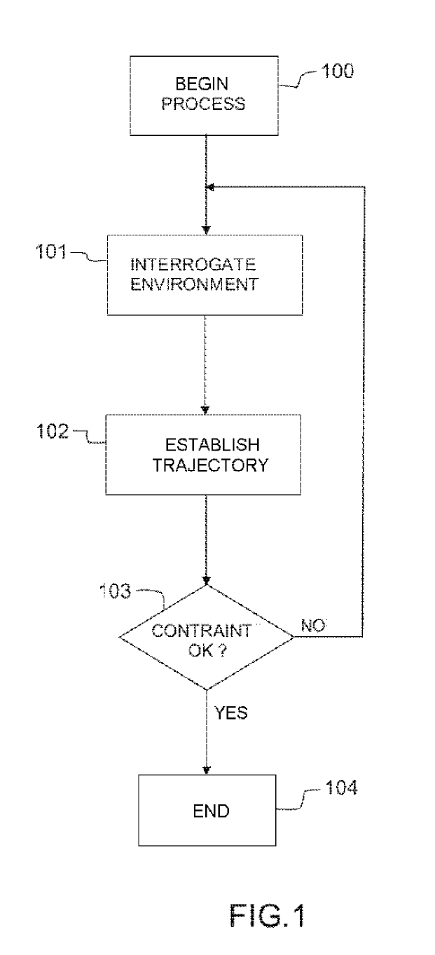

FIG. 1 gives an exemplary diagram illustrating the principle of the simulation method according to the invention;

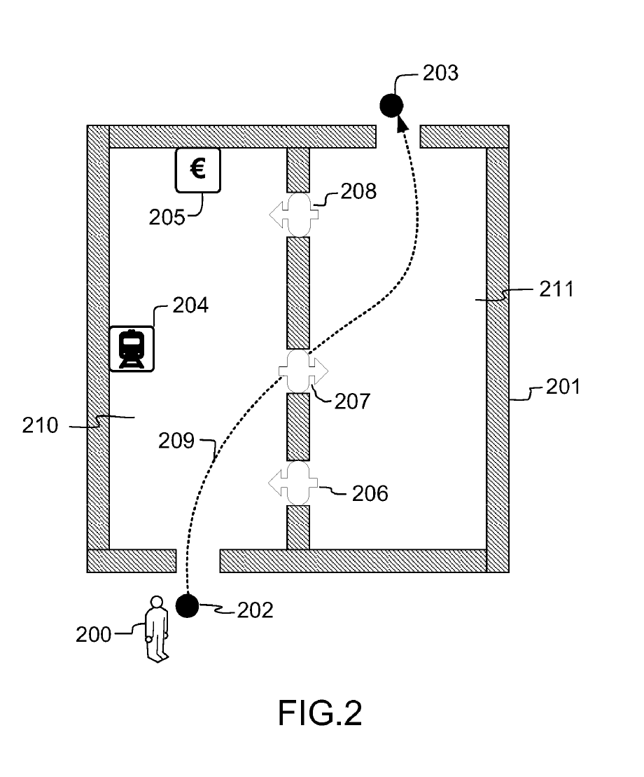

FIG. 2 presents a graphical representation of an infrastructure of subway station type in which an intelligent agent is travelling around;

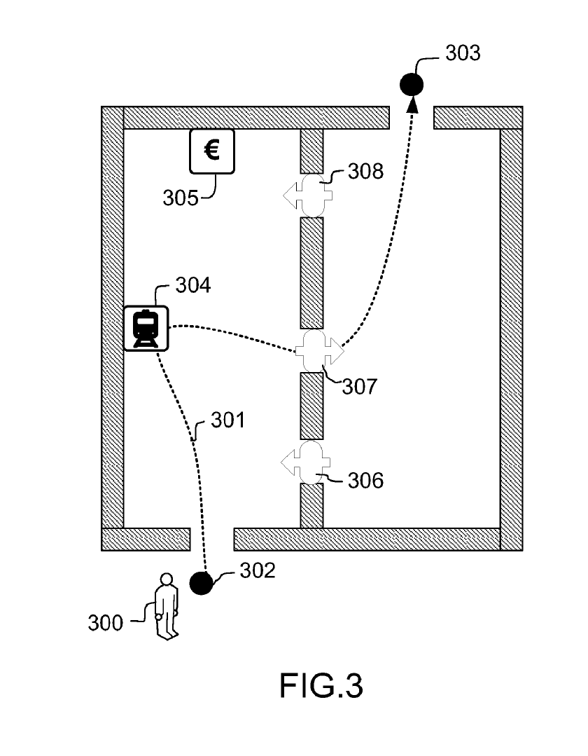

FIG. 3 gives an exemplary path calculated in such a way that an intelligent agent can obtain a ticket in an infrastructure of subway station type;

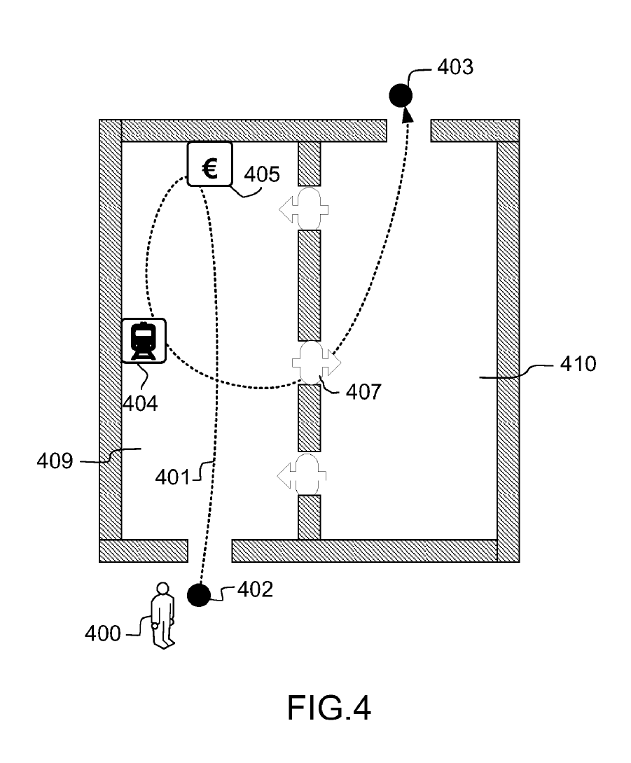

FIG. 4 gives an exemplary path recalculated in such a way that the constraint “obtain money” is satisfied;

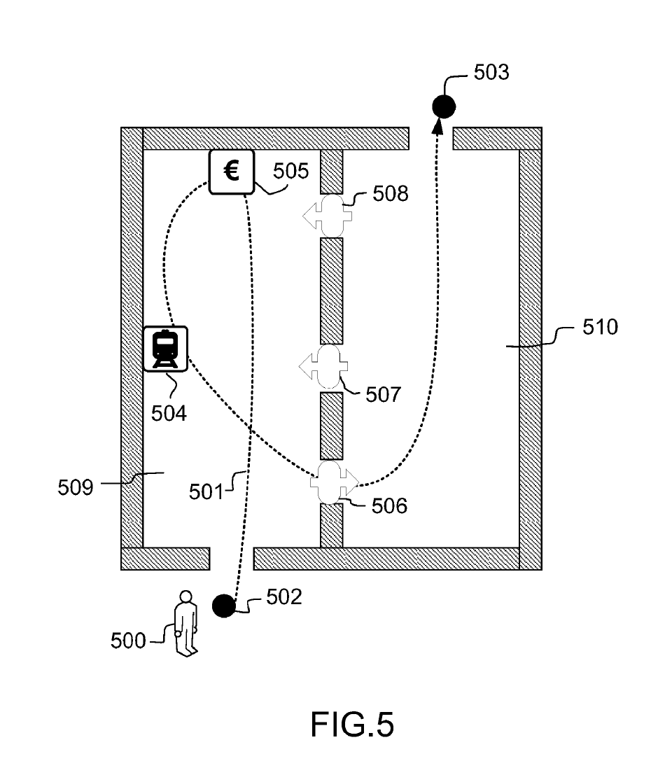

FIG. 5 gives an exemplary path calculated after reconfiguration of two interactive objects included in the subway station represented;

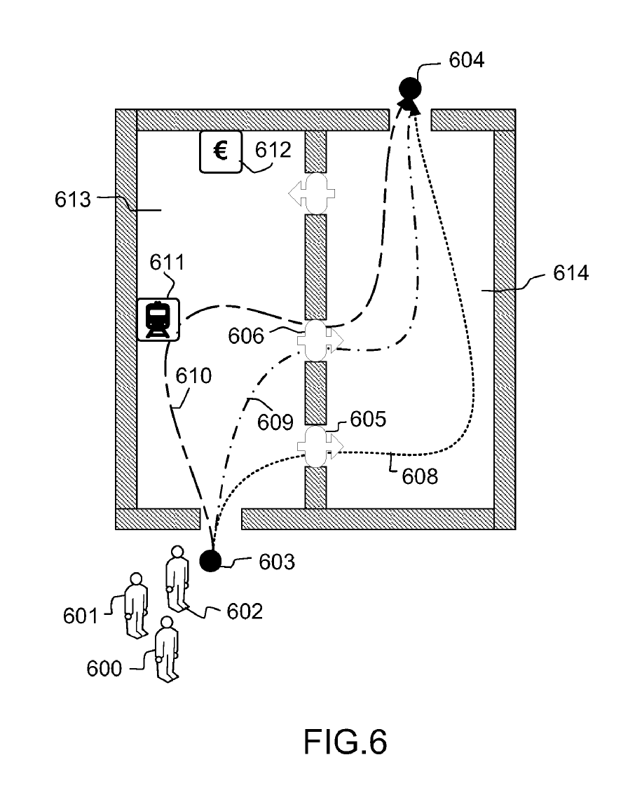

FIG. 6 gives examples of trajectories calculated by the method for intelligent agents configured in different ways;

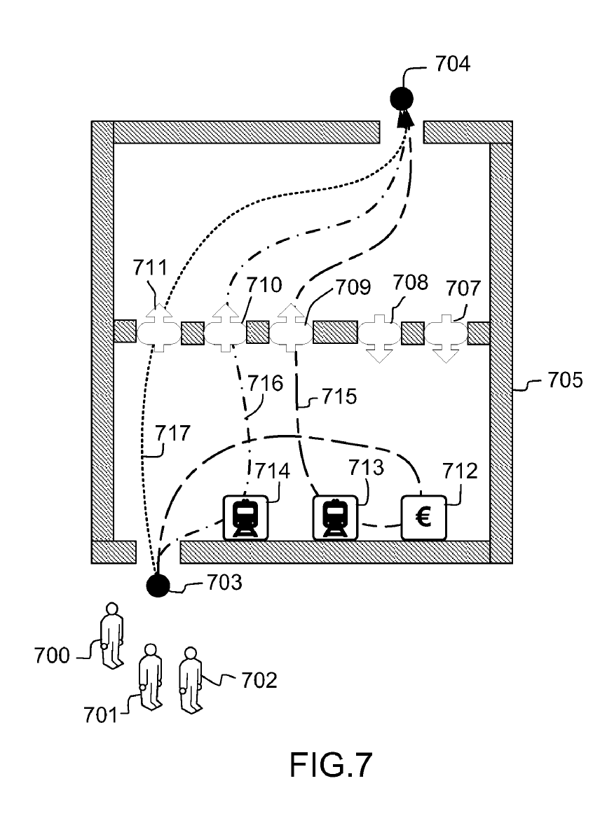

FIG. 7 gives examples of trajectories calculated when interactive objects are moved or added in the subway station;

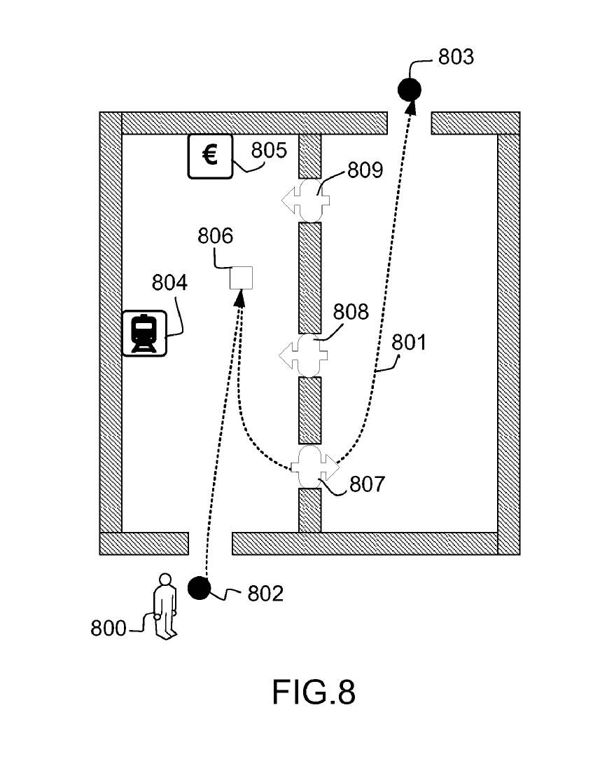

FIG. 8 gives another exemplary calculation of trajectories calculated subsequent to the addition of an interactive object of ticket type on the floor of one of the halls of the station.

FIG. 1 gives an exemplary diagram illustrating the principle of the simulation method according to the invention.

The proposed solution proposes the placing at the disposal of the user of tools, for example implemented by computer, containing notably intelligent agent and interactive object libraries.

The intelligent agents represent living beings. Their behavior is defined in real time as a function of simulated elements, for example inspired by biology. These agents have objectives and motivations of their own and interactive objects might be able to help them to reach them or to satisfy them. The intelligent agents are animated by Artificial Life and Intelligence engines whose programming is such that they exhibit realistic autonomous behaviors, close to those that may be observed in respect of real humans. Notably, these intelligent agents are capable of searching for and of finding in their environment objects able to help them to reach their aims or to satisfy their motivations. Interactions between intelligent agents and interactive objects emerge from the simulated behaviors able to faithfully reproduce what would be the real behaviors of humans in a real infrastructure, were it to be equipped with these objects. The intelligent agents taking part in the simulation are endowed with capabilities for adapting to their environment and to dynamic modifications, if any, of the latter.

The various characteristics associated with an intelligent agent are stored in an agent profile. Thus, a profile comprises, for example, the objective or objectives of the agent, whether or not it possesses money, the speed at which it walks on average, etc.

The interactive objects represent physical objects with which may be associated functions of their own and allowing them to interact with their environment, and notably with the intelligent agents. They possess, for example, mechanical behaviors or characteristics that the virtual agents can utilize to reach their aims or satisfy their motivations. The interactive objects are defined and programmed in such a way that, solely through their arrangement in the synthetic environment, that is to say in the three-dimensional representation of the infrastructure, they can influence the behavior of the intelligent agents with which they interact and define, intrinsically, new behavioral laws for these agents.

Certain interactive objects are directly involved in the algorithms which define the trajectories governing the movements of the intelligent agents. These objects, called path-objects in the subsequent description, are for example elevators, conveyor belts, access barriers or doors. The path-objects are automatically taken into account by so-called path-search algorithms, such as for example the A* algorithm, the D* algorithm, the Z* algorithm or an algorithm of arc segment planning type. The path-search algorithms allow the intelligent agents to define their trajectory from their current position to a target position. The path-objects thus defined can demand particular conditions from the intelligent agents so that they can pass through them. For example, a path-object representing a ticket barrier in a railroad station may demand that an intelligent agent possess a ticket in order to be able to pass through it.

The various characteristics associated with an interactive object are stored in an object profile. Thus, an object profile comprises, for example, the conditions of use of the object. Thus, the profile of an interactive object of note dispenser type indicates, for example, that it dispenses notes if the intelligent agent desiring to use it possesses a debit card, the indication of possession of this card appearing in the agent profile of said intelligent agent. The necessity to possess a payment card is an example of an interactive object usage constraint.

The interactive objects make it possible to define behavioral laws. Stated otherwise, the interactive objects can reference, in their associated profile, generic characteristics of other objects and of their ties with the intelligent agents. For example, an interactive object of ticket barrier type placed in a railroad station refers to a generic object of ticket type which must be possessed by an intelligent agent so that it can pass. An intelligent agent whose motivations urge it to pass through the ticket barrier object is informed that it needs a ticket. It can thereafter scan its environment while interrogating the other intelligent agents or the interactive objects present in its vicinity so that it knows where and how it can obtain a ticket. An interactive object of ticket dispenser type indicates for example that it can issue a ticket with the proviso that it is supplied with money. Thus, the arrangement of the various objects in the environment will automatically modify the behaviors of the intelligent agents. The interactive objects are able to condition the movements of the intelligent agents. There exist for example interactive objects through which the agents must pass such as barriers, or doors. These interactive objects comprise in their profile the conditions of their crossing. These conditions, seen as constraints by the intelligent agents and designated as such in the subsequent description, may be automatically comprehended and utilized by the agents during the establishing of their trajectories.

Thus, the method according to the invention comprises a number of independent processes for all the intelligent agents introduced into the analyzed infrastructure. A process comprises, for example, several steps.

After the commencement of the process 100 associated with a given intelligent agent, a first step 101 is aimed at interrogating the environment of the agent. Thus, a search makes it possible to identify any interactive objects or intelligent agents necessary for reaching the objectives and/or satisfying the motivations of the intelligent agent. Accordingly, constraints related to these objectives and/or motivations are associated with them. These constraints must be taken into account by the intelligent agent so that the latter can reach its objectives. Thus, an intelligent agent moving around in a railroad station and wishing to access a platform of said railroad station may need a ticket in order to reach its objective. This constraint “possession of a ticket” is necessary in order to reach the objective “reach the platform” and must therefore be satisfied. The function of the step 101 of interrogating the environment is to locate an interactive object making it possible to obtain a ticket. This search in the close environment of the intelligent agent is carried out for example by interrogating the profile of all the interactive objects in a given radius R and within range of the agent. Indeed, the profile of an interactive object at a distance r<R from the agent but inaccessible to the latter, for example placed in a room that the agent cannot reach, is not interrogated.

A second step 102 will calculate the path so that the intelligent agent reaches its objective while satisfying the constraint “possession of a ticket”. Accordingly, the path is calculated in such a way that it passes via an interactive object of ticket dispenser type, for example. This calculation is carried out by known algorithms of path-search type, examples of which were given above.

A third step 103 thereafter verifies that the set of constraints required in order to reach the objective of the intelligent agent are satisfied. If such is the case, the calculated path is validated and the process terminates 104. Otherwise, an additional iteration is required since other constraints have not been satisfied. The path is therefore recalculated in an iterative manner until all the constraints are satisfied. If this is impossible, the intelligent agent cannot reach its objectives. In this case it remains in situ or exits the infrastructure, for example.

An exemplary application of the method according to the invention is described in the subsequent description and various cases are tackled, supported by FIGS. 2 to 8.

FIG. 2 presents a graphical representation of an infrastructure of subway station type in which an intelligent agent is travelling around.

The infrastructure of this example corresponds to a simplified subway station 201. The objective of an intelligent agent 200 is to get from its initial position at the entrance of the station 202 to its arrival position corresponding for example to the access to the platforms 203. The station is divided into two halls 210, 211 and the agent must pass from the first hall 210 to the second hall 211 so as to be able to access the platforms. Access from one hall to the other is effected with the help of ticket barriers 206, 207, 208 simulated by interactive objects of path-objects type. A so-called upper ticket barrier 208 at the extremity of the first hall and a so-called central ticket barrier 207 make it possible to pass from the second 211 to the first hall 210. A third, so-called lower, ticket barrier 206 placed near the entrance of the first hall makes it possible to pass from the first 210 to the second hall 211.

The first hall 210 comprises an interactive object of ticket dispenser type 204 and an interactive object of note dispenser type 205.

A path 209 is initially calculated by the process associated with the intelligent agent 200 with the help of an arbitrary path-search algorithm. The result of the execution of this algorithm is a path passing through a path-object 207 of ticket access barrier type, said barrier being the lone ticket barrier allowing passage from the first hall 210 to the second hall 211.

A second iteration of the process associated with the intelligent agent 200 will make it possible to recalculate the path in such a way that the agent can obtain a ticket, that is to say satisfy the constraint “possession of a ticket”.

FIG. 3 gives an exemplary path calculated in such a way that an intelligent agent can obtain a ticket.

The ticket access barrier 307 accessible from the first hall 309 of the subway station is an interactive object which specifies to the intelligent agent 300 that it requires a ticket to let it pass through. The intelligent agent 300 then interrogates the environment to ask which interactive object is able to provide it with a ticket.

A ticket dispenser 304 is an interactive object which issues tickets. Thus, during the step, described previously in the description, of interrogating the environment, the profile of said object is interrogated and the object will respond to the agent that it can buy a ticket from it.

The trajectory 301 of the agent from its starting position 302 to its arrival position 303 is then recalculated and is thereby modified. The trajectory passes through the interactive object ticket dispenser 304. An interactive object of note dispenser type 305 is present in the first hall but is not taken into account at this juncture by the process associated with the intelligent agent 300.

FIG. 4 gives an exemplary path recalculated in such a way that the constraint “obtain money” is satisfied.

The interactive object of ticket dispenser type 404 of the first hall 409 specifies in its profile that it requires money in order to issue a ticket. The intelligent agent 400 interrogates the environment during a third iteration in order to ask which interactive object within its range is able to provide it with money. A note dispenser 405 in the first hall 409 is an interactive object which issues money and it will therefore respond to the agent 400 that it can supply it therewith.

The trajectory 401 of the intelligent agent 400 is thereby modified. The agent passes initially via the note dispenser 405 and thereafter arrives at the ticket dispenser 404, passes through the ticket barrier 407 allowing it to access the second hall 410 and reach its arrival position 403.

The trajectory is valid since all the objects that it passes through have indicated constraints which will be fulfilled. It is validated and the intelligent agent 400 can begin to move by heading toward the note dispenser.

FIG. 5 gives an exemplary path recalculated after reconfiguration of one or more interactive objects included in the subway station represented.

As explained previously, the method comprises a set of iterative processes associated with the intelligent agents. The trajectory is established by automatically taking into account the constraints related to the envisaged trajectories until a possible trajectory has been established or it has been judged impossible to of solve said constraints. The user of the tool implementing the method can act on the interactive objects of the simulation. For example, he can change the direction of passage of the ticket access barriers 506, 507, 508 by modifying their profiles.

Thus, if the user decides to change the direction of the central barrier 507 and of the lower barrier 506, the trajectory of the agent is automatically updated with respect to that calculated by the method and presented with the help of FIG. 4, the process associated with the intelligent agent taking into account the modifications of profiles.

Subsequent to this update, the trajectory passes through the lower barrier 506, the only barrier making it possible to access the second hall 510 from the first hall 509 and therefore the only one making it possible to attain the arrival destination for the intelligent agent 500.

If the user does not change the direction of the lower barrier 506 in his profile then, no trajectory can be found between the starting point 502 and the arrival point 503. In this case the intelligent agent 500 remains stationary, for example.

Consequently, the automatic calculations of trajectories make it possible to verify the coherence of the infrastructure represented. Stated otherwise, the method makes it possible to produce an interactive infrastructure prototype.

The joint utilization of the intelligence of the objects and of the agents solves numerous cases automatically. For example, by modifying the profile of the intelligent agents that enter the station, the calculations of the trajectories associated therewith are modified.

FIG. 6 gives examples of trajectories calculated for differently configured intelligent agents.

For example, if an intelligent agent 600, 601, 602 is initially provided with a ticket, its trajectory will pass only through a ticket access barrier without passing through a ticket dispenser 611 and a note dispenser 612. Two trajectories are then possible. The first 608 departs from the starting point 603, passes through the first hall 613, crosses the lower ticket barrier 605 and reaches the second hall 614 and then the arrival point 604. The second 609 is similar but passes through the central ticket barrier 606 making it possible to access the second hall 614. Indeed, in the example, there are two possible ticket access barriers for accessing the second hall 614.

It is also possible to grant entry to an intelligent agent 600, 601, 602 initially provided with money but no ticket. In this case, its calculated trajectory will pass only via the ticket dispenser 611 and through a ticket access barrier 605, 606 without passing via a note dispenser 612.

FIG. 7 gives examples of trajectories calculated when interactive objects are moved or added in the subway station represented.

The implementation of the method allows the user to modify the conditions of the simulation dynamically by adding, removing, moving interactive objects and/or intelligent agents. This does not necessitate any modification of the algorithms. Indeed, as the virtual parties are intelligent, they automatically integrate these changes into the establishing of their trajectories by using the updated information returned by the interactive objects.

For example, if a new configuration of ticket access barrier placed in the station 705 is chosen and if said configuration modifies the topology of the subway station, then the intelligent agents will adapt automatically. Indeed, the profile of the modified or added objects is taken into account by the processes associated with each of the intelligent agents. The new configuration comprises for example five barriers 707, 708, 709, 710, 711 separating a first hall from a second hall. Three of these barriers allow the intelligent agents 700, 701, 702 to move in the direction from the starting point 703 to the arrival point 704.

The first hall comprises two ticket dispensers 713, 714 and a note dispenser 712.

Thus an intelligent agent furnished with a ticket can follow a trajectory 717 departing from the starting point 703 and going to the arrival point 704 and passing, for example, through the ticket barrier 711.

When an intelligent agent has no ticket and has no money, an exemplary calculated trajectory 715 shows that said agent can head initially toward the note dispenser 712 and then toward one of the two ticket dispensers 713, the closest being for example favored during the trajectory calculation, thereafter pass through one of the ticket barriers 709 in order to reach the arrival point 704, that is to say the point of access to the platforms.

When an intelligent agent has no ticket but has money, an exemplary calculated trajectory 716 shows that said agent can head toward one of the two ticket dispensers 714, the closest being for example favored during the trajectory calculation, thereafter pass through one of the ticket barriers 710 in order to reach the arrival point 704.

It is this immediate consideration by the intelligence of the system which renders the solution suitable for the fast production of prototypes of infrastructures. The user of a system implementing the method can test various configurations of the infrastructure and, for example, optimize the flows of passengers based on the results of the simulations.

FIG. 8 gives another exemplary calculation of trajectories calculated subsequent to the addition of an interactive object of ticket type on the floor of one of the halls of the station.

As explained previously, during the movements of the agents following the established trajectories, said agents are capable of reacting to modifications of the environment. Accordingly, the processes associated with them may be executed repeatedly, this execution being triggered for example subsequent to a modification of the environment. A modification of the environment can correspond to the addition, to the removal, to the movement of an interactive object or else correspond to the addition, to the removal, to the movement of one or more intelligent agents.

For example, if during a journey to one of the ticket access barriers chosen during a previous calculation of trajectory, said barrier changes direction by modification of its profile, the process associated with the intelligent agent will plan a new trajectory. The latter will then pass through a correctly oriented barrier.

If an intelligent agent 800 not provided with a ticket detects an 806 on its journey to the note dispenser, it is capable of recovering the ticket and of adapting its trajectory 801. Indeed, after having bought the ticket, the intelligent agent 800 no longer needs to pass via either a note dispenser 805 or via a ticket dispenser 804 and can move directly to a ticket barrier 807 and then to the destination 803.

One of the advantages of the method according to the invention is that a large number of virtual agents and of interactive objects having different properties, that is to say different profiles, may be simulated in a given infrastructure. A process as described above is for example associated with each of them. The process is executed periodically or/and when a given event is detected. Thus, it is possible to modify the properties of the simulation dynamically without stopping it.

1. A method for simulating behaviors in a reconfigurable infrastructure represented in three dimensions, said infrastructure comprising interactive objects, the characteristics of an interactive object are described in an object profile, the behavior of users of the infrastructure able to move around therein being simulated by intelligent agents, the characteristics of an intelligent agent being described in an agent profile comprising at least one item of information indicating a main objective of said intelligent agent, the method comprising
executing a trajectory calculation process associated with a given agent comprising:
in a first step, analyzing profiles of the interactive objects of the infrastructure and identifying those whose use by the agent is required in order to reach an objective termed the current objective, the current objective corresponding initially to the main objective;
in a second step, calculating or recalculating a trajectory with the help of a path-search algorithm, said trajectory making it possible to reach the main objective by using the interactive objects identified in the previous step; and
in a third step, performing a check to verify whether the trajectory calculated during the second step is valid; if the trajectory is valid, the trajectory is taken into account for the movements of the intelligent agent; if the trajectory is not valid, at least one constraint included in an interactive object profile invalidating the trajectory is identified and the trajectory calculation process is executed again from the first step, the current objective being to satisfy the identified constraint.

2. The method according to claim 1, wherein the main objective of an agent corresponds to a geographical destination in the three-dimensional representation of the infrastructure.

3. The method according to claim 1, wherein during the first step, the analysis of profiles of the interactive objects is carried out on the profiles of the interactive objects present in a given radius R around the current position of the agent.

4. The method according to claim 1, wherein when the calculated trajectory is not valid and at least one constraint contained in the invalidating interactive object profile cannot be satisfied, the intelligent agent remains stationary.

5. The method according to claim 1, wherein interactive objects and/or intelligent agents may be added or removed at any moment in the three-dimensional representation of the infrastructure.

6. The method according to claim 1, wherein the profiles of the interactive objects and the profiles of the intelligent agents are modifiable at any moment of the execution of the method.

7. The method according to claim 1, wherein the trajectory calculation processes associated with the intelligent agents are executed periodically.

8. The method according to claims 5, wherein the trajectory calculation process associated with the given intelligent agent is executed when an object profile or an agent profile is modified as well as when an interactive object or an intelligent agent is added to the three-dimensional representation of the infrastructure.

9. A system for simulating behaviors in a reconfigurable infrastructure represented in three dimensions, said infrastructure comprising interactive objects, the characteristics of an interactive object are described in an object profile, the behavior of users able to move in the infrastructure being simulated by intelligent agents, the characteristics of an intelligent agent being described in an agent profile comprising at least one item of information indicating the main objective of said intelligent agent, the system being configured to execute a trajectory calculation process associated with a given agent comprising:
in a first step, analyzing profiles of the interactive objects of the infrastructure and identifying those whose use by the agent is required in order to reach an objective termed the current objective, the current objective corresponding initially to the main objective;
in a second step, calculating or recalculating a trajectory with the help of a path-search algorithm, said trajectory making it possible to reach the main objective by using the interactive objects identified in the previous step; and
in a third step, performing a check to verify whether the trajectory calculated during the second step is valid; if the trajectory is valid, the trajectory is taken into account for the movements of the intelligent agent; if the trajectory is not valid, at least one constraint included in an interactive object profile invalidating the trajectory is identified and the trajectory calculation process is executed again from the first step, the current objective being to satisfy the identified constraint.

10. The system according to claim 9, wherein the main objective of an agent corresponds to a geographical destination in the three-dimensional representation of the infrastructure.

11. The system according to claim 9, wherein during the first step, the analysis of profiles of the interactive objects is carried out on the profiles of the interactive objects present in a given radius R around the current position of the agent.

12. The system according to claim 9, wherein when the calculated trajectory is not valid and at least one constraint contained in the invalidating interactive object profile cannot be satisfied, the intelligent agent remains stationary.

13. The system according to claim 9, wherein interactive objects and/or intelligent agents may be added or removed at any moment in the three-dimensional representation of the infrastructure.

14. The system according to claim 9, wherein the profiles of the interactive objects and the profiles of the intelligent agents are modifiable at any moment of the execution of the method.

15. The system according to claim 9, wherein the trajectory calculation processes associated with the intelligent agents are executed periodically.

16. The system according to claim 12, wherein the trajectory calculation process associated with the given intelligent agent is executed when an object profile or an agent profile is modified as well as when an interactive object or an intelligent agent is added to the three-dimensional representation of the infrastructure.
